(19) United States
(12) Patent Application Publication
(10) Pub. No.: US 2015/0278388 A1
(43) Pub. Date: Oct. 1, 2015

(54) DYNAMICALLY RE-SKINNING A WEB USER INTERFACE

(71) Applicant: TITUS INC., Ottawa (CA)

(72) Inventors: Svetozar Markov, Ottawa (CA); Xiaoming Fan, Ottawa (CA); Paul Anthony Reid, Brockville (CA)

(21) Appl. No.: 14/443,167

(22) PCT Filed: Nov. 15, 2013
(86) PCT No.: PCT/CA2013/050876

§ 371 Date: May 15, 2015

Related U.S. Application Data
(60) Provisional application No. 61/727,098, filed on Nov. 15, 2012.
(60) Provisional application No. 61/727,101, filed on Nov. 15, 2012.

(51) Int. Cl. G06F 17/30; G06F 17/21; G06F 3/0484

(52) U.S. Cl. CPC G06F 17/30896; G06F 3/04847; G06F 3/04842; G06F 17/212; G06F 17/30905

(57) ABSTRACT

In accordance with an aspect of the present disclosure there is provided a method, non-transitory computer readable memory and system for dynamically re-skinning a web user interface to enable the display of user interface elements that map to the original web application interface. An attribute associated with the electronic device for presenting the web user interface is determined. The attribute is used to determine that modification of the user interface is required. The web application is modified to hide one or more user interface elements of the web user interface based upon the determined attribute. The web user interface is rendered on the electronic device but is not visible. One or more new user interface elements are created based upon the determined attribute. A modified user interface is then rendered on the electronic device having the one or more new user interface elements providing functions of the original web application.

### TECHNICAL FIELD

The present disclosure relates to user interfaces on computing devices and in particular to dynamically re-skinning web applications, services, and content for the computing device.

### BACKGROUND

Web based applications or services can provide interface to enable dynamic user access or interaction with data, such as for example in e-mail, calendar, contacts, document management, consumer and cloud services/applications. The webpages are dynamically generated to be accessed by a web based interface. The web access interface may be configurable to a type of device such as a desktop computer, mobile device or embedded devices. However applications may not be designed to be directly usable on different access devices having different display characteristics than originally designed for. For example an e-mail web access client, such as Outlook web access™ (OWA) client may be designed for desktop or larger display format browser and not provide an equivalent mobile format to be accessible on a mobile device browser. Access on the mobile device to the e-mail web access client would therefore be cumbersome and difficult to navigate and present information or features which a user may not want or require on the device. Accordingly, systems and methods that enable dynamically re-skinning web user interface remains highly desirable.

### SUMMARY

In accordance with an aspect of the present disclosure there is provided a method of dynamically re-skinning a web user interface by a processor of an electronic device, the method comprising: determining an attribute associated with the electronic device for presenting the web user interface; modifying web application to hide one or more user interface elements of the web user interface based upon the determined attribute; rendering the web user interface on the electronic device; creating one or more new user interface elements based upon the determined attribute; and rendering a modified user interface on the electronic device having the one or more new user interface elements.

In accordance with another aspect of the present disclosure there is provided a non-transitory computer readable memory containing instructions for dynamically re-skinning a web user interface, the instructions which when executed by a processor performing: determining an attribute associated with the electronic device for presenting the web user interface; modifying web application to hide one or more user interface elements of the web user interface based upon the determined attribute; rendering the web user interface on the electronic device; creating one or more new user interface elements based upon the determined attribute; and rendering a modified user interface on the electronic device having the one or more new user interface elements.

In accordance with yet another aspect of the present disclosure there is provided a system of dynamically re-skinning a web user interface, the system comprising: a web server for providing a web application via communications network; an electronic device coupled to the communications network, the electronic device for performing: determining an attribute associated with the electronic device for presenting the web user interface; modifying web application to hide one or more user interface elements of the web user interface based upon the determined attribute; rendering the web user interface on the device; creating one or more new user interface elements based upon the determined attribute; and rendering a modified user interface on the device having the one or more new user interface elements.

### BRIEF DESCRIPTION OF THE DRAWINGS

Further features and advantages of the present disclosure will become apparent from the following detailed description, taken in combination with the appended drawings, in which:

FIG. 1 shows a representation of dynamically re-skinning an e-mail web application interface and the modified client interface;

FIG. 2 shows a representation of HTML code of the e-mail content and HTML code for presentation of the first message of FIG. 1;

FIG. 3 shows a method of dynamically re-skinning a web user interface at a client device;

FIG. 4 shows another method of dynamically re-skinning web applications.

FIG. 5 shows a representation of a system for providing dynamically re-skinning web user interface;

FIG. 6 shows a screenshot of a re-skinned web application adding additional user interface elements; and

FIG. 7 shows a screenshot of policy configuration for providing a re-skinned web user interface to control interface elements in the modified client interface.

It will be noted that throughout the appended drawings, like features are identified by like reference numerals.

### DETAILED DESCRIPTION

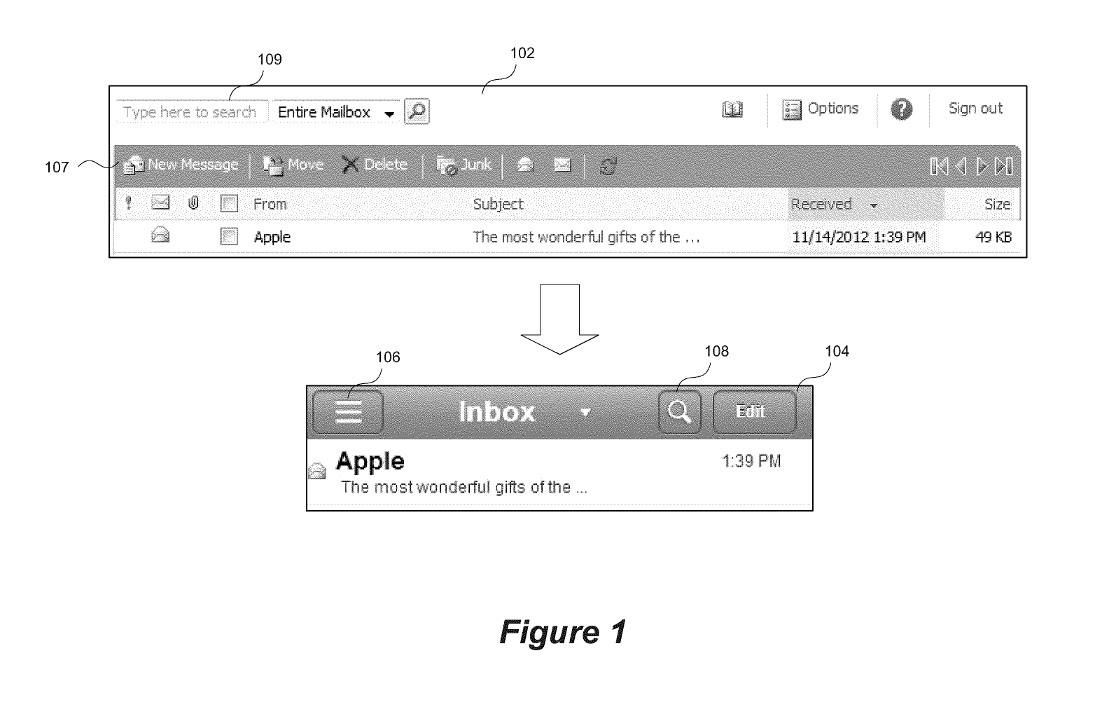

Embodiments are described below, by way of example only, with reference to FIGS. 1-7.

User interfaces (UI) that are provided by web-based applications, or interface with web services or content can be limited to the types of devices or display areas that they can be presented on. For example, basic version of OWA™ works on mobile devices, but its UI deficiencies make it useless as it was designed for a larger display browser. In addition, applications on mobile devices may present only a subset of features present in the full ‘desktop’ version of the web application and may not allow extensibility or third-party plug-ins to be enabled to provide additional functionality. In order to enable web applications to function in environments that they were not designed for, a system and method for dynamically re-skinning or modifying the web user interfaces associated with web-based applications, services or content is provided. The original user interface is suppressed by modification of the scripting used to generate the web-based application. The original code, or implementation can be modified and used to generate elements of the modified interface and enable interaction with the original interface.

Sources (XML, HTML, aspx, JavaScript, CSS) can be modified as well as binaries, but the existing signed third-party binaries are not deleted or modified.

In the following description and examples it is assumed that the web application is ASP.NET, but the described method will work with any framework supporting inline server scripting including, but not limited to: PHP, CGI/Perl, JSP, Ruby on Rails (RoR), Python etc.

In every HTML/ASPX page to be re-skinned, existing UI element are enclosed in an invisible <div>, <span>, <section>, or other HTML markup tags. JavaScript code is inserted in the page body on load( ) event or any other spot where the injected code will be executed to parse the DOM object, extract page data and use it to construct a modified or new UI. Alternatively, the existing UI elements may be modified for presentation if possible, for example changing graphic properties, placement, or interaction elements.

The alteration may be performed based upon:
Page universal resource locator (URL), content and metadata—For example, messages recognized as “CONFIDENTIAL”, either by their classification metadata or by their visual markings, would be replaced by stubs for mobile devices;
Product license—For example, when the product license is valid, and, in case of temporary license, not expired, the re-skinning doesn't happen, or users will lose some or all functionality;
Client browser, client device, connection type/speed—The re-skinning could be targeted to specific clients/browsers, based on various client characteristics—browser name, version, user-agent tag; presence or absence of certain browser-dependent JavaScript features; client windows/viewport dimensions, etc.;
User identity—For example, different users can be presented with different classification controls and policies based upon attributes of a user;

Device location—the device location can determine the UI elements or access to content;

Administrator policy—can be used to associate policy groups with control definitions and control selection items to be presented in the UI. The administrator policy can define which content in the UI is visible and how to modify existing UI elements and which new elements to add to the UI, for example classification properties. The policy may also define blocking of actions of features associated with UI elements and the conditions under which actions are blocked. In the example of an e-mail application custom X-Header information can be defined for messages to be applied for message classification metadata.
3^{rd} party plug-ins—additional features may be integrated with the web user interface based upon data or metadata provided by additional services or applications and may be linked to administrator policy in defining action that may occur based upon specific actions. For example classification policy such as security classifications such as but not limited to Unclassified, Confidential, Restricted, Internal Use Only, Secret, etc. can be selected by the user. The 3^{rd} party plug-in may perform additional actions like data retrieval and integration into the modified UI, policy enforcement, attribute determination, menu presentation, and dynamic UI modification.

After the construction, the new (or modified) UI either replaces the original UI and becomes visible or is rendered in a separate UI container. Re-skinned (modified) UI can use the same event handlers as the original in this case the workflow and business logic of original application remain intact—or it can completely replace them.

Key components of dynamically re-skinning the UI:
Original web application aspx/html pages to be re-skinned that provide html output;
Invisible UI container (e.g. <div>, <span>, or <section>) enclosing the primary (original) UI elements;
JavaScript code inserted in page onLoad( ) event handler or any other spot where the injected code will be executed after the page is loaded and rendered, e.g. script element in the page body or jQuery.ready( ) handler)
Additional functionality can be provided, for example licensing and configuration management, by using optional code-behind libraries or server side scripts.

As shown in FIG. 1, a web access client is shown in an unmodified user interface display such as in a desktop browser 102. Only the first message in the Inbox is shown in a desktop browser. When the user interface is requested to a device on which it is not optimized, it is dynamically re-skinned and the UI elements are modified to be presented in an optimized (modified) UI 104, for example on a device having smaller display characteristics such as a mobile device. Only first message in the Inbox is shown in a mobile browser as well. The original UI is modified to remove elements such as received date, size, message selections, headers and menu options which are not required or efficient to access with the device interface. Additional UI elements may be added which may map to original actions, for example menu UI element 106 can map back to menu items 107 in the original UI, search UI element 108 can may back to search input 109 in the original UI. The dynamically re-skinned UI enables user interfaces that have not be designed for different device attributes to be dynamically modified and also allow integration of administration policy in the presentation of the UI in addition to integrating 3^{rd} party plug-ins such as security classification.

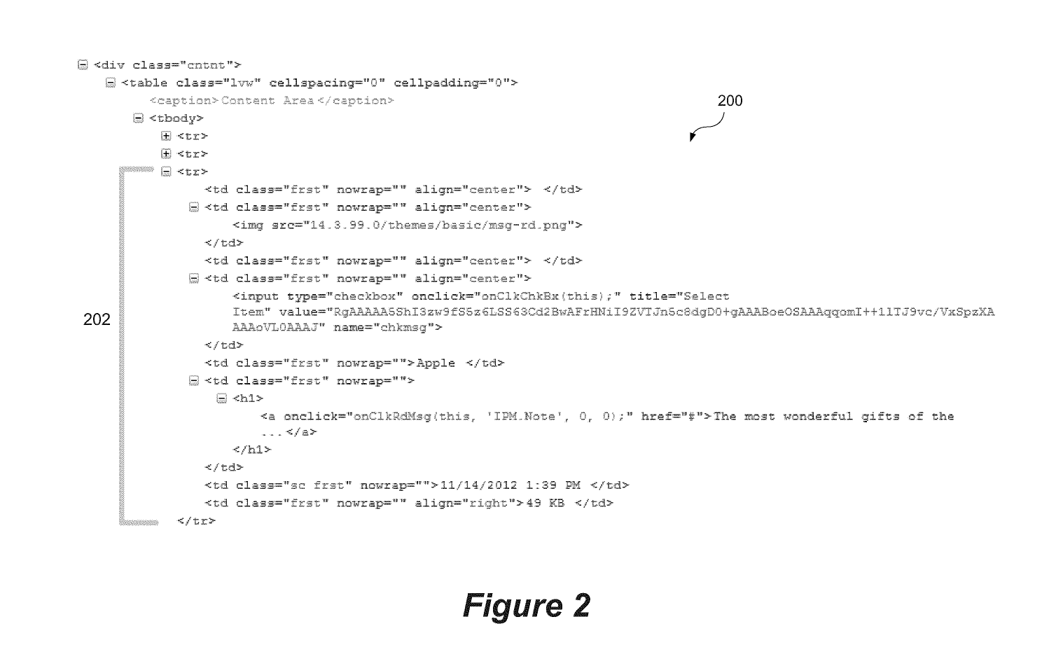

As shown in FIG. 2. Example HTML code 200 for presentation of the first message of e-mail content of FIG. 1 is shown 202. Only portions of the code that is relevant to the modified user interface is presented.

Note that the re-skinned page could be changed as follows:
has different color/font scheme
has fewer controls or additional controls are added(order by buttons, mark as buttons, select message checkboxes)
shows more or less information (message size, date, metadata, classification properties, etc.)
shows message subject as a regular text, not a link.
interface optimized user interface elements, for example touch interface
additional UI elements leveraging additional device features including tactile/haptic feedback, audio or other interfaces as provided by the device
Additional UI elements provided by a content source such guided classification

To implement the dynamic interface the original code is modified based upon device, user, policy or location attributes. In the present example of a web-mail client using JavaScript to present the user interface a custom JavaScript library is added. The JavaScript is added to the page header and referenced from any spot in the page body

In the originating Web application, service or content, as an example basicmessageview.aspx, a custom JavaScript library is included in the page header (contains LoadTitusMailContent( )function): which reads the html code of original message list, parse each message for html, and construct a new format of message list to replace the original interface. This element could be made invisible by JavaScript or CSS for example:

<script src=“14.2.318.4/scripts/basic/TitusScripts.js”>
</script>

Execute re-skinning code after page is loaded (body JavaScript):

<script type=“text/javascript” language=“javascript”>
LoadTitusMailContent( ) ;

Mail content container original:

<div class=“cntnt”>
<%RenderListView( ) ;%>
</div>

The primary (original) user interface renders, although it is configured not to be displayed, elements of the primary (original) interface can be accessed by the modified UI elements. For example, Mail content container in the re-skinned page can be provided by:

```
<div id=“OWAContent” class=“cntnt”
    style=“display:none; overflow: hidden;”>
  <%RenderListView( ) ;%>
</div>
```

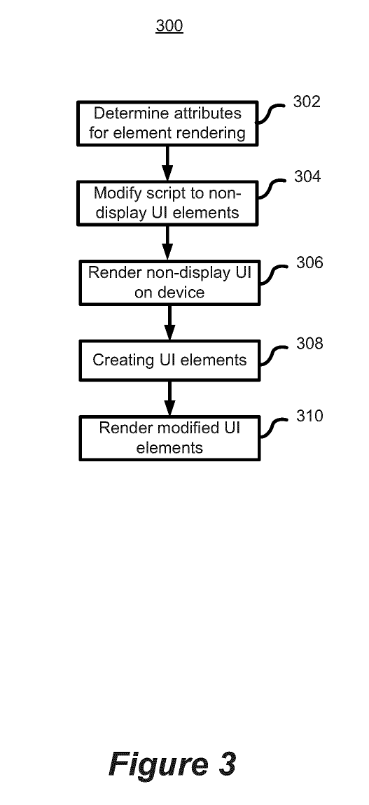

FIG. 3 shows a method 300 of dynamically re-skinning web applications. The server scripting code for the original user interface is stored on a server and requested by a device. When the requesting device does not match a default device the code needs to be modified to enable a modified user interface to be displayed and to integrate additional functionality not provided by the original user interface. Attributes associated with the requestor or device (such as size, resolution, location, application type, agent type, user credentials, administrative or security policy, location parameters, etc.) are determined (302). The determination may be performed by the server or by the device or a combination thereof. The script to present the user interface is modified to suppress the primary (original) user interface and execute the modified user interface (304) by marking elements in the user interface as non-display elements by the associated functions may still be available. The configuration of the modified user interface is pre-defined by administrative configuration. The administrator can pre-define the configuration by identifying which UI elements are display, modified, or added to the original UI. The administrator may also identify integration of UI elements which require 3^{rd} party plug-in or content integration. The UI elements can be headings, columns, menus, buttons, selection input, graphics, reformatting content presentation etc. The device renders the primary (original) user interface the elements of the UI that have been marked as non-display are not shown (306). Elements of the UI are then created, or modified from existing UI elements, (308) which can be mapped to existing hidden UI elements. The modified UI can be rendered on the display of the device (310). Additional extension elements are also provided in the modified user interface such as classification or other dynamically added content or functionality.

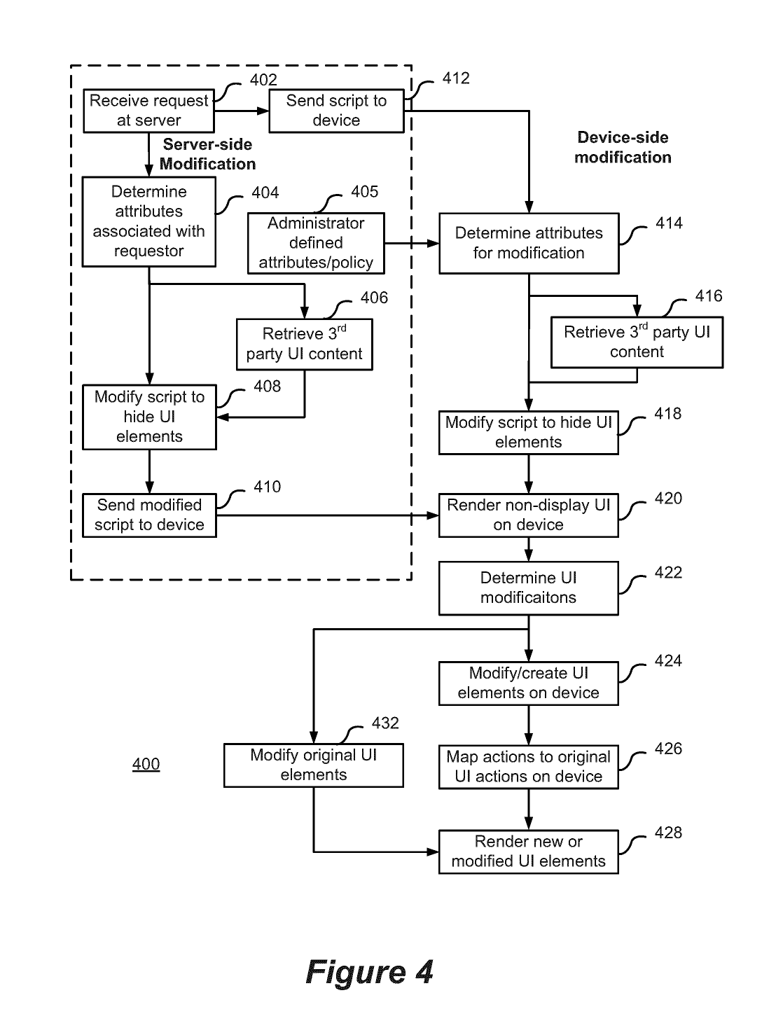

FIG. 4 shows a method of dynamically re-skinning web user interfaces. The request to a web-application such as an .aspx (active server pages ASP.NET) is received (402) at a web server. Depending on the configuration of the device, the script to generate the UI may be sent directly to the device (412) or may be modified before being sent to the device. If modification occurs at the server, attributes associated with the requestor, (such as size, resolution, location, application type, agent type, user credentials, administrative or security policy, location parameters, etc.) are determined (404). For example the user agent ID in a web browser may be used to determine if the request came from a device that requires UI modification due to screen sizing such as a Smartphone. If the compatibility characteristics defined by the attributes matches the default characteristics of the web-application then no modification is required and the web application code is provided to the device for rendering in a browser application. If the attribute does not match the default, the source can be modified to identify that the user interface, or elements in the interface are not displayed (408), although it is still rendered (having a display type of none) to enable access to the functionality. The modified script sent to the device (410). If 3^{rd} party elements are to be integrated with the user interface they can be retrieved (406) and the script modified to include additional UI elements, such as for example classification policy or security enforcement controls.

If the device is modifying the user interface, rather than the server, the original web interface is received by the device. The device can then determine attributes for modification (414) of the UI. The attributes may be determined by the device, such as browser type, screen resolution etc., but may also include administrator defined attributes (405) provided by the server either during initial installation or on an as required basis. The administrator defined attributes may define policy for how, when, and where information is to be presented, and how 3^{rd} party plug-ins or UI content or interface elements are integrated. If additional 3^{rd} party plug-ins or UI elements or content are identified, they are retrieved (416) by the device. The web UI script is modified by the device to hide UI elements are not to be displayed in the device (418). The non-displayed original UI is rendered to enable access to functions and characteristics of the UI elements (420) for example control event handlers. The modifications to the UI that are required are determined (422). The modification may be dynamically determined on the device or provided by administrative policy/configuration received from the server. UI elements are modified or created to provide additional functionality (424) such as for example security policy selection, portion marking or redaction or other functionality relative to the intended consumption of the content. Content (for example mail items, calendar events, contact information, documents, data elements, etc.) to be displayed in the UI interface are also processed based upon the modified UI characteristics limiting representations or reformatting of information to be consistent with the modified UI. Actions that occur in the modified UI are mapped to the original UI interface (426) which enables interaction with the web-server to be provided seamlessly. The modified UI is then rendered to the display (428). Depending on the extent of the modification required, only existing or original UI elements may be required to be modified (432).

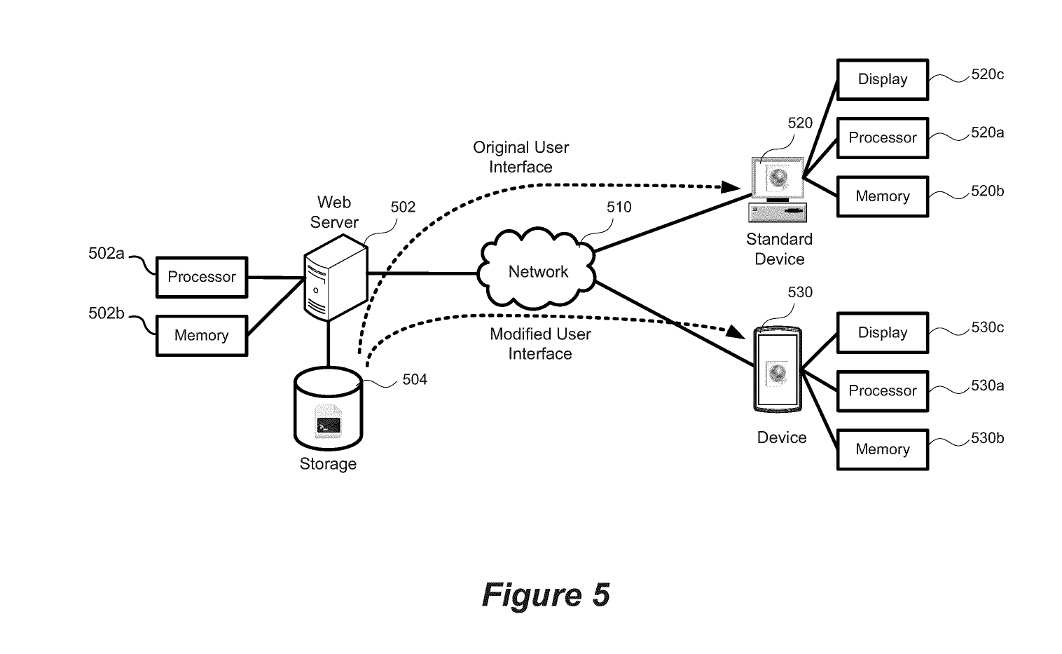

FIG. 5 shows a representation of a system for providing dynamically re-skinning web applications. The system comprises a web server 502 which may have or not have coupled storage 504 containing data used in generating the web application and the content to be provided in the application. The server comprises at least a processor 502a and memory 502b and may also be coupled to a display and input devices (not shown) and networks. The server 502 is coupled to a network which enables access by devices 520 and 530 to request web applications or services. A standard device 502, that is a device that the user interface is originally designed for the web application such as a desktop browser, full browser application or other device types that support equivalent functionality, such as but not limited to Explorer™, Safari™, Chrome™ and Firefox™, etc. receives the web application which is executed by a processor 502a and memory 502b and presented on a display 520c or other output devices (sound, tactile or haptic feedback). A device for which the web application is not optimized for, such as a mobile device 530, comprising processor 530a, memory 530b and display 530c, either cannot display the web application properly or provides a cumbersome implementation of the application and requires a modified interface. When the server 502 determines that the http request originates from a mobile device 530 (or a device where display of the original UI would be sub-optimal) having an attribute associated with the device based upon device properties, software properties, user profile; policy, classification, licensing, location are determined. The user interface can then be modified (or re-skinned) and provided with same/similar/modified actions which interacts with web server/service.

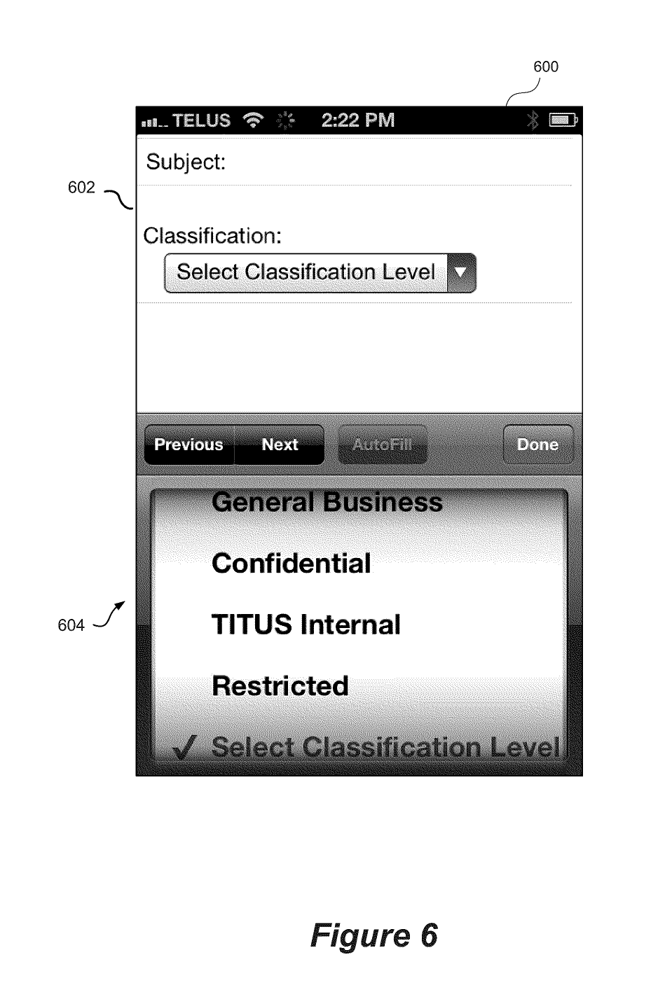

FIG. 6 shows a screenshot of a re-skinned web application providing classification. In this representation and an e-mail message window 600 is provided with additional elements 602 not present in the original web application. In this example the additional element is a classification selection which provides the user with multiple classifications 604 that can be applied to the message. The classification is provided by the 3^{rd} party plug-in and defines classification properties that can be assigned e-mail messages in the modified UI. The classification information would not have been available in the original UI.

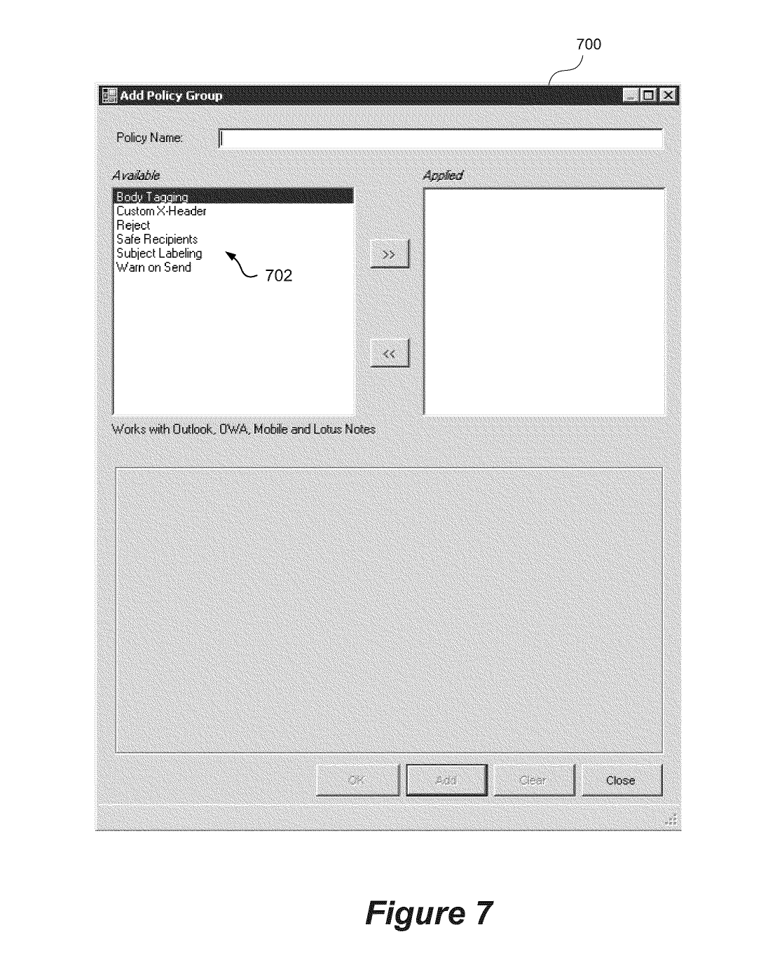

FIG. 7 shows a screenshot of policy configuration 700 for providing a re-skinned web application on the web server. The selection defines what options are dynamically added to the web application for presentation to the user in the modified UI. The modified UI may be generated based upon the determined attributes and a defined policy (User, context, classification, location, time of day, threat status, etc. . . . ) The policy is defined by an administrator and determines how the modification of the original user interface occurs, what is displayed, what is not displayed, actions that can be performed, modifications to content such as e-mail messages that are to occur, and distribution restrictions. The ability to re-skin a web application enables administrators to add or remove features and enforce corporate policies that would not be possible in the original web application. The administrator configuration/attributes can be stored on a server and retrieved when the web application is instantiated or may be stored locally on the device for use when the device access the web application.

The 3^{rd} party application features can be used to display or enable classification properties to be associated with the content such as an e-mail or documents, or portions therein. In addition the modified user interface may enable visual cues inserted within the content, or identification in the metadata in standard format to ensure classification properties are appropriately identified and transmitted. Automatic insertion of visual markings in the content or metadata may be provided via integration of the user interface elements into the modified user interface. Custom properties that are associated with the content travel with the content and reflect the classification of the content and can be integrated with rights management systems to limit access and distribution of document based upon the associated classification. The modified user interface can also integrate corporate policy into the modified user interface to limited access, viewing, or distribution of content. The interface may be dynamically modified based upon determined attributes associated with the device, user, location, etc. For example if a user accesses the web application via a device that has not been authorized the modified user interface may limit functionality available. Alternatively if the user accesses the application via a trusted network or provides appropriate credentials additional elements such as classification options may be provided or the levels of classification available may be increased or decreased. The policy associated with the application and/or the user can be used to define the user interface that is provided and the associated features/functions that are available.

Event driven logic is utilized to force user to classify content based upon action performed within the user interface. Prevention or warning can be displayed when the user attempts to downgrade a classification of content. In the downgrade prevent mode, if the user tries to downgrade the classification, for example from SECRET to UNCLASSIFIED, they can be prevented based upon the existing properties associated with it. Alternatively the content can be automatically classified based on the user's profile. For example, all users in the finance department could be configured to automatically apply a classification of FINANCIAL INFO to all their documents. Visual markings within the document such as header, footer or watermarks can be automatically inserted based upon the selected classification.

Context sensitive classification selections which change based on user selection can also be provided by the user interface. For example, if the user selects CONFIDENTIAL as a classification they can then be prompted to indicate which department generated the confidential information and how long the information should be retained as a corporate record.

Although the implementation of dynamically re-skinning web applications has been described in regards to mobile devices, the web application user interface may be modified in relation to any number of devices for which a web application may not be optimized for display or execution. For example where a web application is designed for a large display area device such as a desktop computer, but may be present on small display devices, mobile device, tablets, kiosk, or other places including wearable devices, etc. having different display characteristics such as size, resolution, color depth, interface type, processing power, etc.

Although the description discloses example methods, system and apparatus including, among other components, software executed on hardware, it should be noted that such methods and apparatus are merely illustrative and should not be considered as limiting. It is contemplated that any or all of these hardware and software components could be embodied exclusively in hardware, exclusively in software, exclusively in firmware, or in any combination of hardware, software, and/or firmware. Accordingly, while the following describes example methods and apparatus, persons having ordinary skill in the art will readily appreciate that the examples provided are not the only way to implement such methods and apparatus.

In some embodiments, any suitable computer readable memory can be used for storing instructions for performing the processes described herein. For example, in some embodiments, computer readable media can be transitory or non-transitory. For example, non-transitory computer readable media can include media such as magnetic media (such as hard disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable memory that is not fleeting or devoid of any semblance of permanence during transmission, and/or any suitable tangible media.

1. A method of dynamically re-skinning a web user interface by a processor of an electronic device, the method comprising:
determining an attribute associated with the electronic device for presenting the web user interface;
modifying a web application to hide one or more user interface elements of the web user interface based upon the determined attribute;
rendering the web user interface on the electronic device;
creating one or more new user interface elements based upon the determined attribute; and
rendering a modified user interface on the electronic device having the one or more new user interface elements.

2. The method of claim 1 wherein creating one or more new user interface elements are mapped to the hidden one or more user interface elements.

3. The method of claim 1 further comprising mapping the hidden one or more user interface elements to at least one of the one more new user interface elements.

4. The method of claim 1 further comprising mapping interactions between the new user interface elements to actions associated with the hidden one or more user interface elements.

5. The method of claim 1 wherein creating one or more new user interface elements comprises modifying the hidden one or more user interface elements.

6. The method of any one of claims 1 to 5 wherein the one or more user interface elements integrates 3^{rd} party content not previously part of the web application.

7. The method of claim 6 wherein the 3^{rd} party content is associated with document classifications.

8. The method of claim 7 wherein the document classification is a security classification.

9. The method of any one of claims 1 to 8 wherein modifying the web application further comprises retrieving a configuration file to determine the UI elements to be modified within the web application.

10. The method of any one of claims 1 to 9 wherein modifying the web application occurs at a server based upon attributes determined at the server, a modified web application being sent to the electronic device.

11. The method of any one of claims 1 to 9 wherein modifying the web application occurs at the electronic device based upon attributes determined at a server.

12. The method of any one of claims 1 to 9 wherein the modification of the web application occurs at the electronic device based upon attributes determined at the electronic device.

13. The method of any one of claims 1 to 12 wherein the modification of the one or more UI elements comprises adding tactile or haptic feedback to at least one of the modified one or more UI elements.

14. The method of any one of claims 1 to 13 wherein the web application is defined in a scripting language.

15. The method of claim 14 wherein the scripting language is selected from a group comprising PHP, CGI/Perl, JSP, Ruby on Rails (RoR), Python.

16. The method of any one of claims 1 to 15 wherein the attribute is one or more of a user agent identifier, a user identifier, a device identifier, device property, an administrator policy, and classification policy.

17. The method of any one of claims 1 to 16 wherein the one or more new UI elements are dynamically generated to enhance an existing web application, service or content based upon the determined attribute.

18. The method of any one of claims 1 to 17 wherein the at least one of the one or more new UI elements are routing identifiers.

19. The method of any one of claims 1 to 18 wherein the modifying of the web application to suppress an original user interface of the web application is performed by defining a non-display variable.

20. The method of any one of claims 1 to 19 wherein web application is executable in web browser.

21. The method of claim 20 further comprising inserting JavaScript or client side scripting language in an HTML body of the web application, the JavaScript or client side scripting language defining the modified user interface.

22. The method of any one of claims 1 to 21 wherein modifying the web application to hide one or more user interface elements is performed by enclosing the one or more UI elements in an invisible <div>, <span>, <section> and JavaScript code is inserted in the page body on load( ) event where the injected code will be executed to parse the DOM object.

23. A non-transitory computer readable memory containing instructions for dynamically re-skinning a web user interface, the instructions which when executed by a processor performing:
determining an attribute associated with the electronic device for presenting the web user interface;
modifying a web application to hide one or more user interface elements of the web user interface based upon the determined attribute;
rendering the web user interface on the electronic device;
creating one or more new user interface elements based upon the determined attribute; and
rendering a modified user interface on the electronic device having the one or more new user interface elements.

24. The non-transitory computer readable memory of claim 23 wherein creating one or more new user interface elements are mapped to the hidden one or more user interface elements.

25. The non-transitory computer readable memory of claim 24 further comprising mapping the hidden one or more user interface elements to at least one of the one more new user interface elements.

26. The non-transitory computer readable memory of claim 25 further comprising mapping interactions between the new user interface elements to actions associated with the hidden one or more user interface elements.

27. The non-transitory computer readable memory of claim 26 wherein creating one or more new user interface elements comprises modifying the hidden one or more user interface elements.

28. The non-transitory computer readable memory of any one of claims 23 to 27 wherein the one or more user interface elements integrates 3^{rd} party content not previously part of the web application.

29. The non-transitory computer readable memory of claim 28 wherein the 3^{rd} party content is associated with document classifications.

30. The non-transitory computer readable memory of claim 29 wherein the document classification is a security classification.

31. The non-transitory computer readable memory of any one of claims 23 to 30 wherein modifying the web application further comprises retrieving a configuration file to determine the UI elements to be modified within the web application.

32. The non-transitory computer readable memory of any one of claims 23 to 30 wherein modifying the web application occurs at a server based upon attributes determined at the server, a modified web application being sent to the electronic device.

33. The non-transitory computer readable memory of any one of claims 23 to 30 wherein modifying the web application occurs at the electronic device based upon attributes determined at a server.

34. The non-transitory computer readable memory of any one of claims 23 to 30 wherein the modification of the web application occurs at the electronic device based upon attributes determined at the electronic device.

35. The non-transitory computer readable memory of any one of claims 23 to 34 wherein the modification of the one or more UI elements comprises adding tactile or haptic feedback to at least one of the modified one or more UI elements.

36. The non-transitory computer readable memory of any one of claims 23 to 35 wherein the web application is defined in a scripting language.

37. The non-transitory computer readable memory of claim 36 wherein the scripting language is selected from a group comprising PHP, CGI/Perl, JSP, Ruby on Rails (RoR), Python.

38. The non-transitory computer readable memory of any one of claims 1 to 37 wherein modifying the web application to hide one or more user interface elements is performed by enclosing the one or more UI elements in an invisible <div>, <span>, <section> and JavaScript code is inserted in the page body on load( ) event where the injected code will be executed to parse the DOM object.

39. A system of dynamically re-skinning a web user interface, the system comprising:
a web server for providing a web application via communications network;
an electronic device coupled to the communications network, the electronic device for performing:
determining an attribute associated with the electronic device for presenting the web user interface;
modifying a web application to hide one or more user interface elements of the web user interface based upon the determined attribute;
rendering the web user interface on the device;
creating one or more new user interface elements based upon the determined attribute; and
rendering a modified user interface on the device having the one or more new user interface elements.

40. The system of claim 38 further comprising the method of claims 2 to 22.
